(19) United States
(12) Patent Application Publication
(10) Pub. No.: US 2021/0174660 A1
(43) Pub. Date: Jun. 10, 2021

(54) ALARM DEVICE FOR CONSTRUCTION MACHINERY

(71) Applicant: KOBELCO CONSTRUCTION MACHINERY CO., LTD., Hiroshima-shi (KR)

(72) Inventors: Yusuke KAMIMURA, Hiroshima (JP); Yoichiro YAMAZAKI, Hiroshima (JP)

(73) Assignee: KOBELCO CONSTRUCTION MACHINERY CO., LTD., Hiroshima-shi (JP)

(21) Appl. No.: 16/769,062

(22) PCT Filed: Nov. 13, 2018
(86) PCT No.: PCT/JP2018/041912

§ 371 Date: Jun. 2, 2020

(30) Foreign Application Priority Data
Dec. 13, 2017 (JP) 2017-239096

(51) Int. Cl. G08B 21/02; G08B 5/36; G08B 21/22; E02F 9/24; E02F 9/26

(52) U.S. Cl. CPC G08B 21/02; G08B 5/36; E02F 9/26; E02F 9/24; G08B 21/22

(57) ABSTRACT

A device capable of appropriately setting a warning zone in the vicinity of a construction machine and appropriately allowing a person in the vicinity of the construction machine to recognize the warning zone includes a first operational information acquisition section for obtaining first operational information indicating a state of at least either a slewing motion or a travel motion of the construction machine, a zone setting section for setting the warning zone in the vicinity of the construction machine according to the first operational information, and a display forming section for forming a display that allows visual recognition of the warning zone, using visible light.

### TECHNICAL FIELD

The present invention relates to an alarm device for providing a warning to a worker or person in the vicinity of a construction machine such as a hydraulic excavator.

### BACKGROUND ART

There is a conventional technique for setting in the vicinity of a hydraulic excavator serving as an example of a construction machine, a dangerous zone in the form of a circle having a size corresponding to, for example, the length of an extended arm and projecting visible light to the dangerous zone to thereby provide a warning to a worker in the vicinity of the hydraulic excavator, as disclosed in Patent Literature 1, for example.

### CITATION LIST

### Patent Literature

Patent Literature 1: Japanese Unexamined Patent Publication No. 2009-121053

### SUMMARY OF INVENTION

In the above-mentioned technique disclosed in Patent Literature 1, the dangerous zone is set in the form of an entire circle around the construction machine such as a hydraulic excavator. However, at this time, the space in which the worker in the vicinity of the construction machine can freely move is excessively restricted. This in turn may reduce the workability at a work site of the construction machine.

For example, when a slewing body of the hydraulic excavator is slewing in a counterclockwise direction, the necessity for a warning is relatively low in the area in right front of the slewing body as compared to the area in left front of the slewing body (on the downstream side in the slewing direction). Nevertheless, in the technique disclosed in Patent Literature 1, visible light is projected to the entire circular area around the hydraulic excavator including the right front area. Consequently, the worker in the vicinity of the hydraulic excavator can move only in an excessively restricted space.

The present invention has been made with the foregoing background in mind and its object resides in providing an alarm device capable of setting an appropriate warning zone according to the level of danger in the vicinity of a construction machine and allowing a person in the vicinity of the construction machine to recognize the warning zone.

In order to achieve the above specified object, an alarm device for a construction machine according to the present invention comprises: a first operational information acquisition section for obtaining first operational information indicating a state of at least either a slewing motion or a travel motion of the construction machine; a zone setting section for setting in the vicinity of the construction machine a warning zone for providing a warning to a person in the vicinity of the construction machine according to the first operational information obtained by the first operational information acquisition section; and a display forming section for forming in the warning zone a display that allows the person in the vicinity of the construction machine to visually recognize the warning zone, using visible light.

### BRIEF DESCRIPTION OF DRAWINGS

FIG. 1 is a side view of a hydraulic excavator serving as an example of a construction machine according to an embodiment of the present invention.

FIG. 2 is a block diagram of a control processing system employed in the hydraulic excavator according to the embodiment of the present invention.

FIG. 3 is a flowchart of processing executed by a controller of the control processing system shown in FIG. 2 in a first embodiment of the present invention.

FIG. 4A is a diagram showing an example of a warning zone set in the case of a slewing motion.

FIG. 4B is a diagram showing an example of the warning zone set in the case of the slewing motion.

FIG. 5A is a diagram showing an example of the warning zone set in the case of the slewing motion.

FIG. 5B is a diagram showing an example of the warning zone set in the case of the slewing motion.

FIG. 6A is a diagram showing an example of the warning zone set in the case of a travel motion.

FIG. 6B is a diagram showing an example of the warning zone set in the case of the travel motion.

FIG. 7A is a graph illustrating a relationship between angles θ1 and θ2 shown in FIGS. 4A to 5B and slewing speed.

FIG. 7B is a graph illustrating a relationship between distance D shown in FIGS. 6A and 6B and travel speed.

FIG. 8 is a flowchart of processing executed by the controller of the control processing system shown in FIG. 2 in a second embodiment of the present invention.

FIG. 9 is a flowchart of processing executed by the controller of the control processing system shown in FIG. 2 in a third embodiment of the present invention.

FIG. 10 is a diagram showing visible lights projected on warning zones in the third embodiment of the present invention.

FIG. 11 is a schematic sectional view for explaining functions of a projector light source and a reflecting mirror according to a modified embodiment of the present invention.

FIG. 12 is a perspective view showing rotational directions of the reflecting mirror shown in FIG. 11.

### DESCRIPTION OF EMBODIMENTS

### First Embodiment

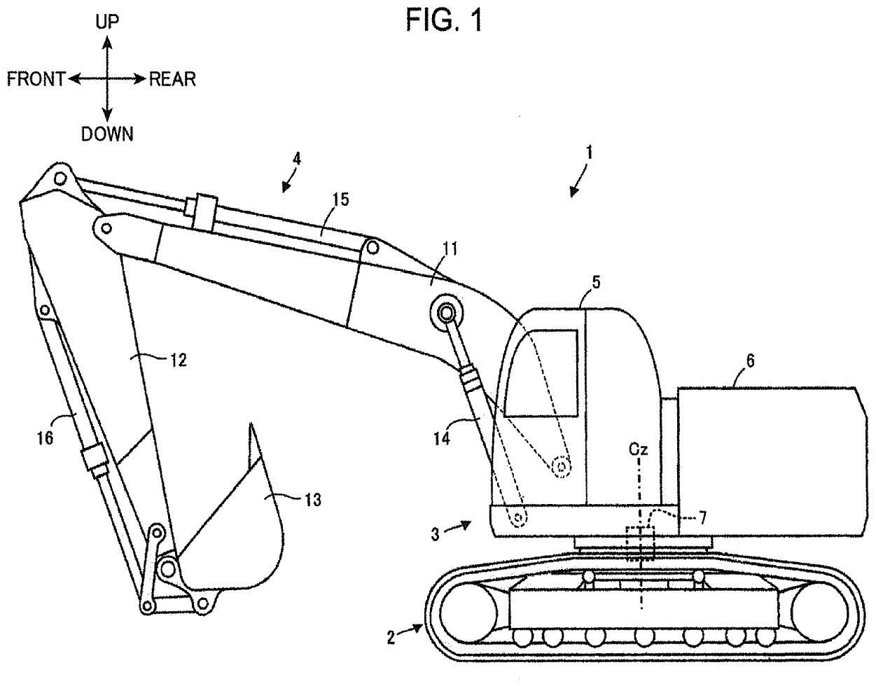

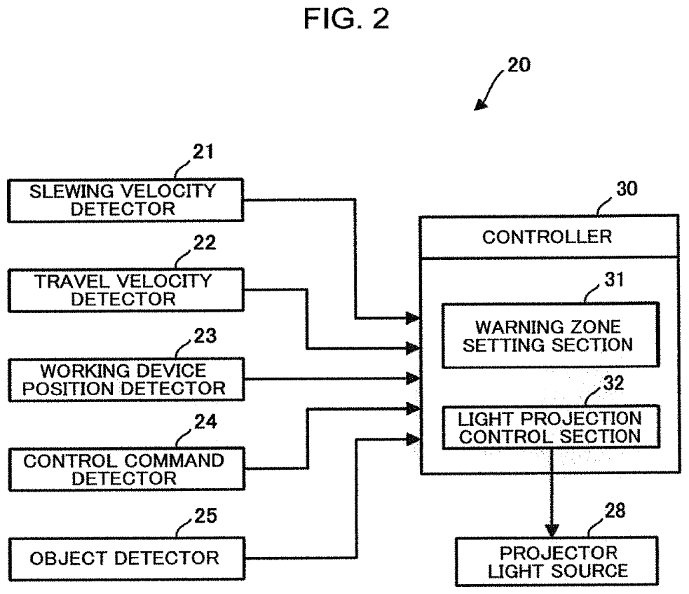

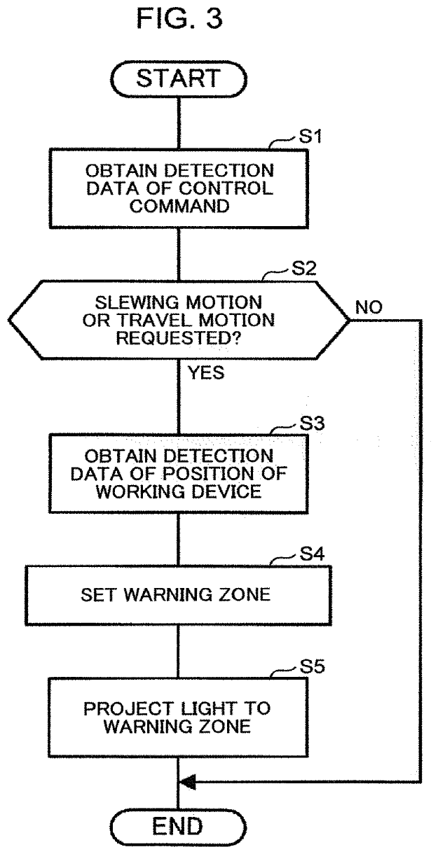

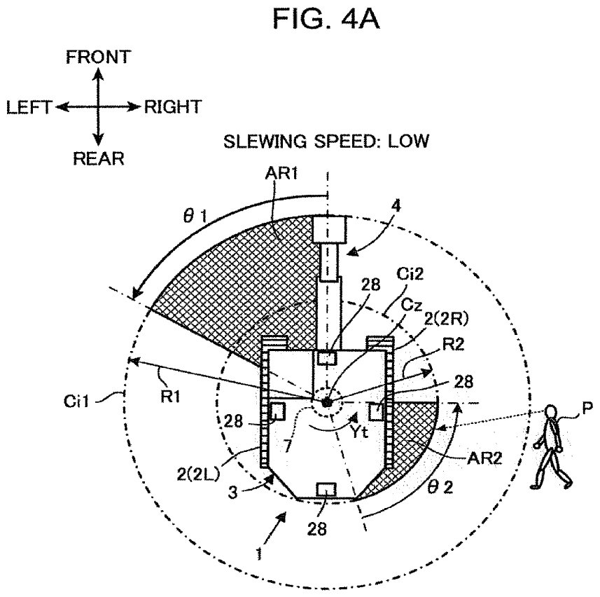

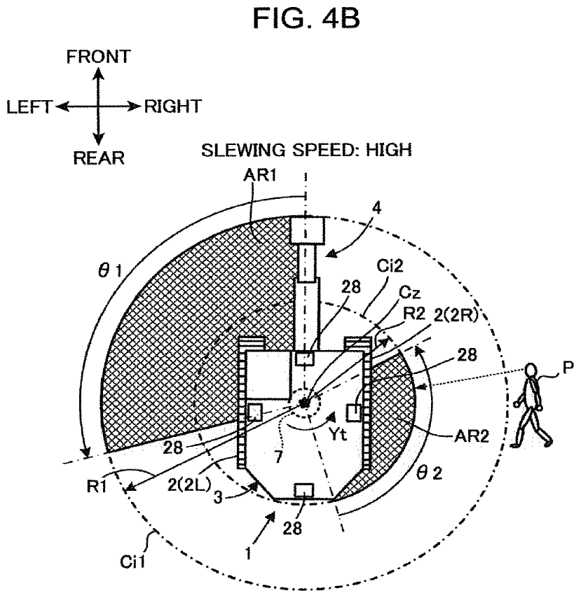

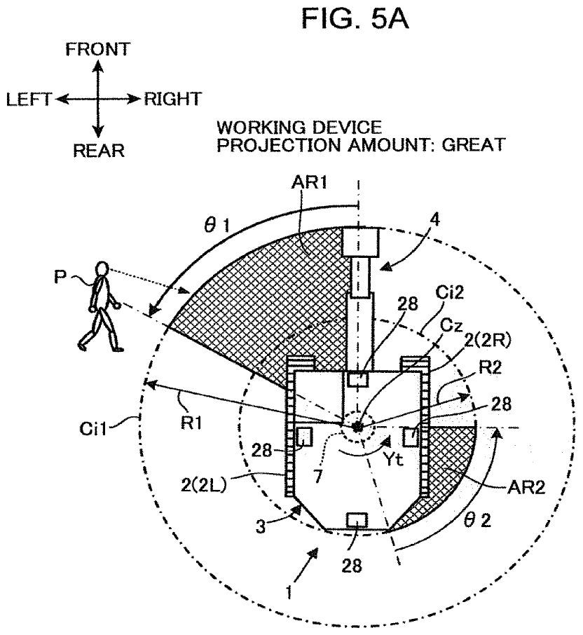

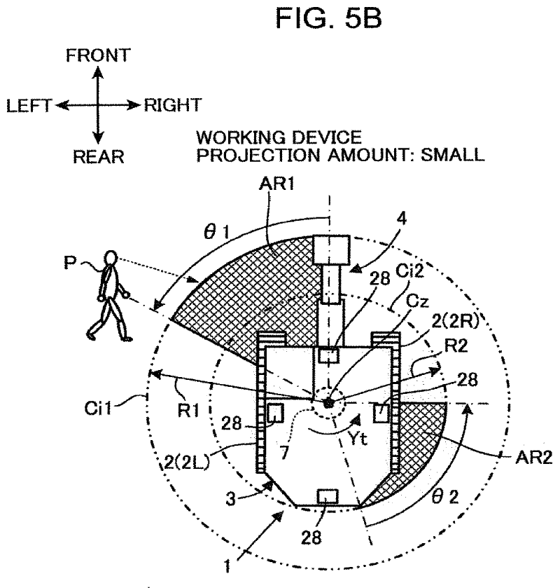

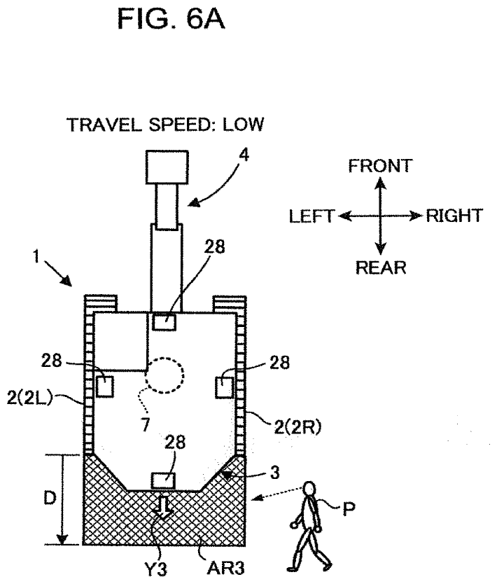

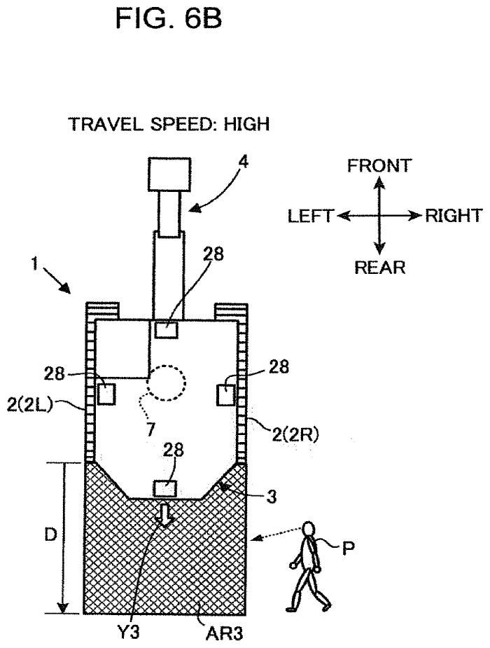

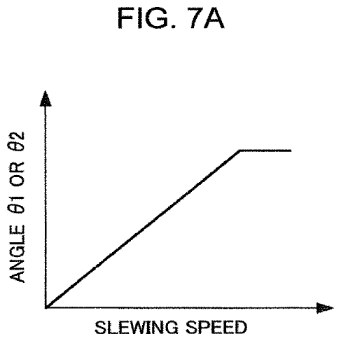

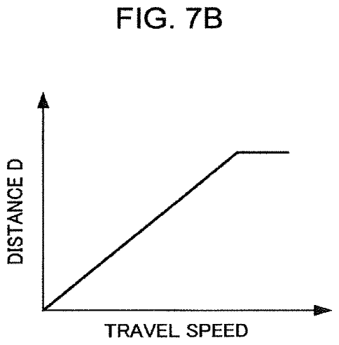

A first embodiment of the present invention will be described with reference to FIGS. 1 to 7B. FIG. 1 is a side view of a hydraulic excavator 1 serving as an example of a construction machine according to an embodiment of the present invention. FIG. 2 is a block diagram of a control processing system 20 employed in the hydraulic excavator 1 according to the embodiment of the present invention. FIG. 3 is a flowchart of processing executed by a controller 30 of the control processing system 20 shown in FIG. 2 in the first embodiment of the present invention. FIGS. 4A, 4B, 5A and 5B show examples of a warning zone set in the case of a slewing motion of the hydraulic excavator 1. FIGS. 6A and 6B show examples of the warning zone set in the case of a travel motion of the hydraulic excavator 1. FIG. 7A is a graph illustrating a relationship between angles θ1 and θ2 shown in FIGS. 4A to 5B and slewing speed. FIG. 7B is a graph illustrating a relationship between distance D shown in FIGS. 6A and 6B and travel speed. With reference to FIG. 1, the hydraulic excavator 1 serving as an example of the construction machine according to the first embodiment includes a crawler-type traveling body 2, a slewing body 3 mounted on the traveling body 2, a movable working device 4 attached to the slewing body 3, an operator's cab 5, a machine chamber 6, and a slewing hydraulic motor 7.

The traveling body 2 includes a pair of left and right crawlers 2R and 2L (FIG. 4A), each of which can be driven by its respective travel hydraulic motor (not shown).

The slewing body 3 is mounted on the traveling body 2 and can be driven by the slewing hydraulic motor 7 to slew about a slewing axis Cz extending in a vertical direction in a predetermined slewing direction (also referred to as “yaw direction”). The slewing body 3 has at its front portion the operator's cab 5 for allowing an operator to be seated therein and at its rear portion the machine chamber 6 for housing an engine and hydraulic devices, for example.

The working device 4 includes a boom 11 extending from the front portion of the slewing body 3, an arm 12 extending from a distal end of the boom 11, an attachment 13 (a bucket in the example shown in the drawing) assembled to a distal end of the arm 12, a boom cylinder 14 for pivoting the boom 11 with respect to the slewing body 3 in a predetermined pivoting direction (also referred to as “pitch direction”, which is a circumferential direction about an axis extending in a left and right direction of the slewing body 3), an arm cylinder 15 for pivoting the arm 12 with respect to the boom 11 in the pitch direction, and an attachment cylinder 16 for pivoting the attachment 13 with respect to the arm 12 in the pitch direction.

Although FIG. 1 illustrates the hydraulic excavator 1 having a basic configuration, the present invention can be applied to other types of hydraulic excavators configured differently from the above-described one. For example, the attachment 13 is not necessarily in the form of a bucket, but may be any other kind of attachment (such as a crusher or a nibbler).

Further, the boom 11 is not necessarily pivotable only in the pitch direction with respect to the slewing body 3, but may also be configured to be driven by an actuator different from the boom cylinder 14 to pivot in the yaw direction with respect to the slewing body 3 or to be movable in the left and right direction of the slewing body 3.

Further, in addition to the working device 4 including the boom 11, an unillustrated dozer blade may also be assembled to the hydraulic excavator 1, for example. Further, the actuators included in the hydraulic excavator 1 are not necessarily of a hydraulic type. The hydraulic excavator 1 may alternatively include electric actuators.

The hydraulic excavator 1 according to the first embodiment further includes the control processing system 20 configured as shown in FIG. 2. The control processing system 20 functions as an example of the alarm device according to the present invention, and includes a slewing velocity detector 21 for detecting a slewing velocity of the slewing body 3, a travel velocity detector 22 for detecting a travel velocity of the traveling body 2, a working device position detector 23 for detecting a position of the working device 4, a control command detector 24 for detecting a control command issued by an unillustrated maneuvering device of the hydraulic excavator 1, an object detector 25 for detecting an object (including a person) in the vicinity of the hydraulic excavator 1, projector light sources 28 each capable of projecting visible light to the vicinity of the hydraulic excavator 1, and the controller 30 for controlling the projector light sources 28.

The slewing velocity detector 21 detects a slewing velocity (rotational velocity about the slewing axis Cz) of the slewing body 3 with respect to the traveling body 2 using, for example, an angular velocity sensor such as a gyro sensor or a sensor (such as a rotary encoder or a resolver) capable of detecting a rotational velocity of the slewing hydraulic motor 7, and outputs detection data indicating the detected value of the slewing velocity to the controller 30.

The travel velocity detector 22 detects a travel velocity of the traveling body 2 using, for example, a GNSS (Global Navigation Satellite System) or a sensor (such as a rotary encoder or a resolver) capable of detecting respective rotational velocities of the left and right travel hydraulic motors of the traveling body 2, and outputs detection data indicating the detected value of the travel velocity to the controller 30.

The working device position detector 23 detects an amount of displacement of the boom 11 with respect to the slewing body 3 (a rotated angle of the boom 11 about its pivotal point), an amount of displacement of the arm 12 with respect to the boom 11 (a rotated angle of the arm 12 about its pivotal point), and an amount of displacement of the attachment 13 with respect to the arm 12 (a rotated angle of the attachment 13 about its pivotal point), using respective sensors, such as a rotary encoder or a potentiometer, and outputs detection data indicating the detected values of the respective amounts of displacement to the controller 30.

Here, in the hydraulic excavator 1, the overall position of the working device 4 with respect to the slewing body 3 is identified by a combination of the respective amounts of displacement of the boom 11, the arm 12, and the attachment 13. Therefore, a combination of the amounts of displacement indicated in the detection data identifies the overall position of the working device 4.

The control command detected by the control command detector 24 is information indicating a request for an operational state of each actuator of the hydraulic excavator 1 (a request for direction and speed of actuation of each actuator), and includes at least a control command relating to the operation of the slewing hydraulic motor 17 and control commands relating to the respective operations of the left and right travel hydraulic motors of the traveling body 2.

In the first embodiment, the control command detector 24 detects, using a pressure sensor, a pilot pressure (pilot pressures applied to two pilot ports of a direction selector valve provided for each of the actuators of the hydraulic excavator 1 for supplying hydraulic oil thereto) generated in response to a manipulation, by an operator of the hydraulic excavator 1, of each of control levers (not shown) for maneuvering a respective one of the actuators, for example. The control command detector 24 then outputs to the controller 30 each detection data indicating the detected value of the pilot pressure as detection data indicating a control command relating to a respective one of the actuators.

Here, in the hydraulic excavator 1, in order to actuate an actuator in a desired direction, the control lever for maneuvering the actuator is manipulated in a direction corresponding to the desired actuation direction of the actuator. At this time, a pilot pressure is applied to one of the two pilot ports of the direction selector valve for supplying hydraulic oil to the actuator that corresponds to the actuation direction of the actuator.

Further, at this time, as the amount of manipulation of the control lever for maneuvering the actuator increases, the pilot pressure applied to the direction selector valve associated with the actuator increases and, in turn, the flow rate of hydraulic oil supplied to the actuator through the direction selector valve increases. Consequently, the actuation speed of the actuator increases.

Therefore, the detected value of the pilot pressure generated in response to a manipulation of each control lever for maneuvering its respective actuator serves as detection data indicating a control command relating to the actuator (specifically, a request for direction and speed of actuation of the actuator).

For example, the detected value of the pilot pressure (hereinafter also referred to as “slewing pilot pressure”) generated in response to a manipulation of the control lever for maneuvering the slewing hydraulic motor 7 indicates a request for direction and speed of actuation of the slewing hydraulic motor 7 (which in turn indicates a request for direction and speed of a slewing motion of the slewing body 3).

Further, the detected values of the pilot pressures (hereinafter also referred to as “travel pilot pressures”) generated in response to a manipulation of the respective control levers for maneuvering the left and right travel hydraulic motors of the traveling body 2 indicate requests for direction and speed of actuation of each of the left and right travel hydraulic motors (which in turn indicate a request for direction and speed of a travel motion of the traveling body 2).

By the way, instead of detecting the above-mentioned pilot pressures, it may be configured to detect the amount (and direction) of manipulation of each control lever for maneuvering its respective actuator using a sensor such as a potentiometer and use each detected value of the manipulation amount as detection data indicating a control command relating to a respective one of the actuators.

Further, in the case where the hydraulic excavator 1 can be remotely maneuvered or in the case where the hydraulic excavator 1 can be automatically operated, command data sent to the hydraulic excavator 1 by an external maneuvering device (not shown) or command data generated by an automatic operation control device can be used as data indicating a control command relating to a specified one of the actuators (a target operation of the specified actuator)

The object detector 25 detects an object (an object placed on the ground or a moving object or person) in the vicinity of the hydraulic excavator 1, using a TOF (Time Of Flight) sensor or a plurality of range finder sensors such as a stereo camera, and outputs their detection data to the controller 30. At this time, the detection data outputted by the object detector 25 includes data indicating the distance and compass direction from the hydraulic excavator 1 to the object (i.e. data indicating the relative position of the object with respect to the hydraulic excavator 1). Each of the range finder sensors is assembled to a peripheral portion of the slewing body 3, for example.

The projector light sources 28 are each in the form of a visible light source such as a laser light source or a projector. In the first embodiment, the plurality of projector light sources 28 are attached to the peripheral portion of the slewing body 3 as shown in, for example, FIG. 4A, in order that they can project visible light onto the ground around the hydraulic excavator 1 (the ground within a predetermined range from the hydraulic excavator 1) throughout substantially 360 degrees (360 degrees in the yaw direction). Each of the projector light sources 28 is configured to be capable of controlling the area of visible light projection to vary within a predetermined range. Therefore, the projector light source 28 may be supported on the slewing body 3 pivotally about a predetermined axis so that it can change the light projection direction. Further, the projector light source 28 may include a plurality of light projecting elements aligned in vertical and horizontal directions.

Although FIG. 4A illustrates the hydraulic excavator 1 including four projector light sources 28, the hydraulic excavator 1 may include more than four projector light sources 28.

Further, although it is sufficient for the projector light source 28 to be capable of emitting only a single color of visible light, such as blue light or red light, the projector light source 28 may be configured to be capable of emitting different colors of visible light simultaneously or selectively, or capable of emitting a predetermined pattern of visible light, such as a reticulate pattern of visible light or a striped pattern of visible light, or capable of adding text information or graphic information to part of the light projection area.

The controller 30 is comprised of one or more electronic circuit units having a microcomputer, a memory and an interface circuit, for example. The controller 30 includes, as functions realized by the embedded hardware and programs (software), a warning zone setting section 31 (zone setting section) for setting a warning zone in the vicinity of the hydraulic excavator 1, and a light projection control section 32 (display forming section) for controlling the projector light sources 28 to emit visible light to the set warning zone. In addition, the controller 30 may further include a function of controlling the operation of the hydraulic excavator 1.

By the way, in the first embodiment, the control command detector 24 corresponds to the first operational information acquisition section of the present invention. In this case, the control command relating to the operation of the slewing hydraulic motor 17 and the control commands relating to the respective operations of the left and right travel hydraulic motors of the traveling body 2 correspond to the first operational information indicating a state of a slewing motion and a state of a travel motion. In addition, the control command relating to the operation of the slewing hydraulic motor 17 corresponds to the command information (directional information and speed information) relating to a direction and a speed of the slewing motion, and the control commands relating to the respective operations of the left and right travel hydraulic motors correspond to the command information (directional information and speed information) relating to a direction and a speed of the travel motion. Thus, the control command detector 24 obtains the first operational information which is information indicating a state of at least either a slewing motion or a travel motion of the hydraulic excavator 1. Further, the first operational information includes directional information which is information relating to a direction of the at least either the slewing motion or the travel motion of the hydraulic excavator 1. Further, the first operational information includes speed information which is information relating to a speed of the at least either the slewing motion or the travel motion of the hydraulic excavator 1.

Further, the working device position detector 23 corresponds to the second operational information acquisition section of the present invention. The working device position detector 23 obtains second operational information which is information indicating a state of operation of the movable working device mounted on the hydraulic excavator 1. In this case, a combination of the respective amounts of displacement of the boom 11, the arm 12, and the attachment 13 corresponds to the second operational information of the present invention.

Further, the warning zone setting section 31 corresponds to the zone setting section of the present invention, the light projection control section 32 and the projector light sources 28 correspond to the display forming section of the present invention, and the object detector 25 corresponds to the object detection section of the present invention. The warning zone setting section 31 sets in the vicinity of the hydraulic excavator 1 the warning zone for providing a warning to a person in the vicinity of the hydraulic excavator 1. At this time, the warning zone setting section 31 sets the warning zone according to the first operational information obtained by the first operational information acquisition section. In particular, the warning zone setting section 31 sets (determines) a position of the warning zone according to the directional information obtained by the first operational information acquisition section. In addition, the warning zone setting section 31 sets (determines) a size of the warning zone according to the speed information obtained by the first operational information acquisition section. Furthermore, the warning zone setting section 31 sets the warning zone according to the second operational information obtained by the second operational information acquisition section.

Further, the light projection control section 32 and the projector light sources 28 form in the warning zone a display that allows a person in the vicinity of the hydraulic excavator 1 to visually recognize the warning zone, using visible light.

Now, operations relating to the projection of light to the vicinity of the hydraulic excavator 1 will be described. During operation of the hydraulic excavator 1, the controller 30 successively performs operations shown in the flowchart of FIG. 3 at a predetermined control processing cycle. At step S1, the controller 30 obtains detection data indicating current control commands from the control command detector 24. At this time, the obtained detection data only needs to include control commands for the slewing hydraulic motor 7 and the left and right travel hydraulic motors.

Next, at step S2, the controller 30 determines, based on the detection data obtained at step S1, whether there is a request for a slewing motion of the slewing body 3 (actuation of the slewing hydraulic motor 7) or a travel motion of the traveling body 2 (actuation of one or both of the left and right travel hydraulic motors).

At this time, the controller 30 determines that a slewing motion of the slewing body 3 is requested (YES at step S2) if the detected value of the slewing pilot pressure generated in response to a manipulation of the control lever for maneuvering the slewing hydraulic motor 7 (or the detected value of the amount of manipulation of the control lever) is greater than or equal to a predetermined value.

On the other hand, the controller 30 determines that a travel motion of the traveling body 2 is requested (YES at step S2) if the detected value of the travel pilot pressure generated in response to a manipulation of at least either of the control levers for maneuvering the left and right travel hydraulic motors of the traveling body 2 (or the detected value of the amount of manipulation of the control lever) is greater than or equal to a predetermined value.

If a negative determination is made at step S2 (NO at step S2) (in the case where neither a slewing motion nor a travel motion is requested), the controller 30 terminates the processing shown in FIG. 3 at the current control processing cycle.

If a positive determination is made at step S2 (YES at step S2)(in the case where one or both of a slewing motion and a travel motion are requested), the controller 30, at the subsequent step S3, obtains detection data indicating a current position of the working device 4 from the working device position detector 23.

Next, at step S4, the controller 30 sets the warning zone in the vicinity of the hydraulic excavator 1. The operation at step S4 is performed by the warning zone setting section 31.

In this operation, the warning zone setting section 31 sets, if it has been determined at step S2 that a slewing motion of the slewing body 3 is requested, warning zones AR1 and AR2 according to the detected value of the pilot pressure generated by the control lever for maneuvering the slewing hydraulic motor 7 (i.e. according to a request for direction and speed of the slewing motion of the slewing body 3 indicated by the pilot pressure), as shown in FIGS. 4A to 5B.

On the other hand, if it has been determined at step S2 that a travel motion of the traveling body 2 is requested, the warning zone setting section 31 sets a warning zone AR3 according to the detected values of the pilot pressures generated by the respective control levers for maneuvering the left and right travel hydraulic motors (i.e. according to a request for direction and speed of the travel motion of the traveling body 2 indicated by the pilot pressures), as shown in FIGS. 6A and 6B.

If both a slewing motion of the slewing body 3 and a travel motion of the traveling body 2 have been requested, the warning zone setting section 31 sets, as the waning area, a composite area consisting of the warning zones AR1 and AR2 associated with the slewing motion and the warning zone AR3 associated with the travel motion.

In the first embodiment, the warning zones AR1 and AR2 associated with a slewing motion are set as follows. The warning zones AR1 and AR2 set by the warning zone setting section 31 when a slewing motion of the slewing body 3 is requested include the warning zone AR1 (hereinafter referred to as “first warning zone AR1”) for providing a warning to avoid contact with the working device 4 slewing with the slewing body 3 and the area AR2 (hereinafter referred to as “second warning zone AR2”) for providing a warning to avoid contact with the slewing body 3. The first warning zone AR1 can be paraphrased as an area for asking a person in the vicinity thereof to move away more urgently than the other areas, to prevent the person from coming into contact with the working device 4 during the slewing motion of the slewing body 3. The second warning zone AR2 can be paraphrased as an area for asking a person in the vicinity thereof to move away more urgently than the other areas, to prevent the person from coming into contact with the slewing body 3 during the slewing motion of the slewing body 3.

The first warning zone AR1 is set, as shown in FIGS. 4A to 5B, on the ground around the hydraulic excavator 1 as a partial area of a circle Ci1 with a radius R1 centered on the slewing axis Cz of the slewing body 3 (a partial area having an outer edge defined by an arc with the radius R1), the partial area extending from a radius coincident with or substantially coincident with an extending direction of the working device 4 as viewed in a plane perpendicular to the slewing axis Cz to a radius at an angle θ1 rotated from the first radius in the slewing direction (the slewing direction requested by the control command) of the slewing body 3 about the slewing axis Cz.

At this time, the warning zone setting section 31 variably sets the radius R1 for the first warning zone AR1 according to the detection data indicating the position of the working device 4. Specifically, the warning zone setting section 31 calculates, based on the detection data indicating the position of the working device 4 and size data relating to the boom 11, the arm 12, and the attachment 13 of the working machine 4 stored in advance in the controller 30, the distance to the distal end of the working device 4 (from the slewing axis Cz, hereinafter the distance will be referred as “working device projection amount”) when the working device 4 is viewed in the plane perpendicular to the slewing axis Cz. Subsequently, the warning zone setting section 31 sets, as the value of the radius R1, the calculated value of the working device projection amount or a value obtained by adding a predetermined margin value to the calculated value.

Further, the warning zone setting section 31 variably sets the angle θ1 for the first warning zone AR1 according to the detection data indicating the control command for the slewing hydraulic motor 7. Specifically, the warning zone setting section 31 sets, as shown in FIG. 7A, the angle θ1 to become greater up to a predetermined upper limit as the slewing speed of the slewing body 3 requested by the control command for the slewing hydraulic motor 7 increases (as the detected value of the slewing pilot pressure increases or the detected value of the amount of manipulation of the slewing control lever increases), using a map prepared in advance or a formula, for example.

In the first embodiment, the first warning zone AR1 is set in the above-described manner. Thus, the first warning zone AR1 is variably set according to the detection data indicating the control command for the slewing hydraulic motor 7 as shown in FIGS. 4A and 4B.

Here, the first warning zone AR1 shown in FIG. 4A illustrates an example of a case where the slewing direction of the slewing body 3 requested by the control command for the slewing hydraulic motor 7 is a counterclockwise direction as indicated by the arrow Yt in the drawing and the slewing speed requested for the slewing body 3 is relatively low, and the first warning zone AR1 shown in FIG. 4B illustrates an example of a case where the slewing direction of the slewing body 3 requested by the control command for the slewing hydraulic motor 7 is the counterclockwise direction as indicated by the arrow Yt in the drawing and the slewing speed requested for the slewing body 3 is relatively high. In FIGS. 4A and 4B, the working device projection amount is the same.

As shown in these FIGS. 4A and 4B, the angle 91 for the first warning zone AR1 is greater in the case (FIG. 4B) where the slewing speed of the slewing body 3 requested by the control command for the slewing hydraulic motor 7 is high than in the case (FIG. 4A) where the requested slewing speed is low. Thus, the first warning zone AR 1 is set to expand in a circumferential direction about the slewing axis Cz (in the yaw direction) as the slewing speed of the slowing body 3 requested by the control command for the slowing hydraulic motor 7 increases.

Further, the first warning zone AR1 is variably set according to the working device projection amount calculated based on the detection data indicating the position of the working device 4, as shown in FIGS. 5A and 5B.

Here, the first warning zone AR1 shown in FIG. 5A illustrates an example of a case where the slewing direction of the slewing body 3 requested by the control command for the slowing hydraulic motor 7 is the counterclockwise direction as indicated by the arrow Yt in the drawing and the working device projection amount is relatively large, and the first warning zone AR1 shown in FIG. 5B illustrates an example of a case where the slewing direction of the slowing body 3 requested by the control command for the slewing hydraulic motor 7 is the counterclockwise direction as indicated by the arrow Yt in the drawing and the working device projection amount is relatively small. In FIGS. 5A and 5B, the slowing speed of the slowing body 3 requested by the control command is the same.

As shown in these FIGS. 5A and 5B, the radius R1 for the first warning zone AR1 is greater in the case (FIG. 5A) where the working device projection amount is large than the case (FIG. 5B) where the working device projection amount is small. Thus, the first warning zone AR 1 is set to increase its radius R1 (i.e. its maximum extent from the slewing axis Cz) as the working device projection amount (the amount of projection of the working device 4 in a direction orthogonal to the slewing axis Cz) corresponding to the position of the working device 4 increases.

The second warning zone AR2 is set, as shown in FIGS. 4A to 5B, on the ground around the hydraulic excavator 1 as a partial area of a circle Ci2 with a radius R2 centered on the slewing axis Cz of the slewing body 3 (a partial area having an outer edge defined by an arc with the radius R2), the partial area extending from a radius extending from the slewing axis Cz to a point on or close to a rear end of the slewing body 3 to a radius at an angle θ2 rotated from the first radius in the slewing direction (the slewing direction requested by the control command) of the slewing body 3 about the slewing axis Cz.

At this time, the radius R2 for the second warning zone AR2 is a predetermined fixed value and is set to, for example, a value corresponding to the maximum distance from the slewing axis Cz to the rear peripheral edge of the slewing body 3 or a value obtained by adding a predetermined margin value to the maximum distance.

Further, the warning zone setting section 31 variably sets the angle θ2 for the second warning zone AR2 according to the detection data indicating the control command for the slewing hydraulic motor 7, in the same manner as in the setting of the angle θ1 for the first warning zone AR1. Specifically, the warning zone setting section 31 sets, as shown in FIG. 7A, the angle θ2 to become greater up to a predetermined upper limit as the slewing speed of the slewing body 3 requested by the control command for the slewing hydraulic motor 7 increases (as the detected value of the slewing pilot pressure increases or the detected value of the amount of manipulation of the slewing control lever increases), using a data table prepared in advance or a formula, for example.

The angle θ2 for the second warning zone AR2 may be set to the same as the angle θ1 for the first warning zone AR1. Further, although in the examples shown in FIGS. 4A to 5B, the start end (extending from the slewing axis Cz to the point on or close to the rear end of the slewing body 3) of the second warning zone AR2 extending through the angle θ2 is set to extend in a direction slightly inclined from the front and rear direction of the slewing body 3, the direction of the starting end may be set to be coincident with a front and rear direction of the slewing body 3.

In the first embodiment, the second warning zone AR2 is set in the above-described manner. Thus, the second warning zone AR2 is set to expand in the circumferential direction about the slewing axis Cz (in the yaw direction) as the slewing speed of the slewing body 3 requested by the control command for the slowing hydraulic motor 7 increases, as shown in FIGS. 4A and 4B. In FIGS. 5A and 5B, the slewing speed of the slewing body 3 is the same, and thus the respective second warning zones AR2 are the same.

By the way, although in the first embodiment, the radius R1 for the first warning zone AR1 and the radius R2 for the second warning zone AR2 are set independently of each other, the radii R1 and R2 may be set to the same value. For example, the radii R1 and R2 may be set to the same value greater than or equal to a greater one of the working device projection amount or the maximum distance from the slewing axis Cz to the outer peripheral edge of the slewing body 3.

The warning zone AR 3 associated with a travel motion of the traveling body 2 is set as follows in the first embodiment. The warning zone AR 3 set by the warning zone setting section 31 when a travel motion of the traveling body 2 is requested is an area for asking a person in the vicinity thereof to move away more urgently than the other areas, to prevent the person from coming into contact with the hydraulic excavator 1 during the travel motion of the traveling body 2.

In the first embodiment, the third warning zone AR3 is set, as shown in FIGS. 6A and 6B, on the ground around the hydraulic excavator 1 as an area extending from a forward end of the traveling body 2 in a moving direction of the traveling body 2 to a position forward away therefrom by a distance D in the moving direction, the area having a width equal to or substantially equal to the width of the traveling body 2 in the left and right direction (or a width obtained by adding a predetermined margin value to the width of the traveling body 2 in the left and right direction). The forward end of the traveling body 2 in the moving direction refers to a front end of the traveling body 2 when the travel direction (the travel direction requested by the control command) of the traveling body 2 is an advancing direction, and refers to a rear end of the traveling body 2 when the travel direction of the traveling body 2 is a retreating direction.

At this time, the warning zone setting section 31 variably sets the distance D for the third warning zone AR3 according to the detection data indicating the control commands for the left and right travel hydraulic motors. Specifically, the warning zone setting section 31 sets, as shown in FIG. 7B, the distance D to become greater up to a predetermined upper limit as the travel speed of the traveling body 2 requested by the respective control commands for the left and right travel hydraulic motors increases (as the average value of the detected values of the travel pilot pressures respectively corresponding to the left and right travel hydraulic motors increases or as the average value of the detected values of the amounts of manipulation of the respective control levers for maneuvering the left and right travel hydraulic motors increases), using a map prepared in advance or a formula, for example.

The distance D set in the case where the travel direction of the traveling body 2 is the retreating direction is greater than the amount of rearward projection of the slewing body 3 from the rear end of the traveling body 2. On the other hand, the distance D set in the case where the travel direction of the traveling body 2 is the advancing direction is greater than the amount of forward projection of the working device 4 from the front end of the traveling body 2.

In the first embodiment, the third warning zone AR3 is set in the above-described manner. Here, FIG. 6A illustrates the third warning zone AR3 set in the case where the traveling body 2 retreats (travels in the direction indicated by the arrow Y3) at a relatively low travel speed, and FIG. 6B illustrates the third warning zone AR3 set in the case where the traveling body 2 retreats (travels in the direction indicated by the arrow Y3) at a relatively high travel speed.

As shown in these FIGS. 6A and 6B, the distance D for the third warning zone AR3 (i.e. the length of the third warning zone AR3 in the moving direction of the traveling body 2) is greater in the case (FIG. 7B) where the travel speed of the traveling body 2 is high than the case (FIG. 7A) where the travel speed of the traveling body 2 is low. Thus, the third warning zone AR3 is set to extend further forward in the moving direction of the traveling body 2 as the requested travel speed of the traveling body 2 increases.

By the way, when the moving speeds of the left and right crawlers 2R and 2L requested by the respective control commands for the left and right travel hydraulic motors are different from each other (i.e. when the traveling body 2 is to be turned), the left and right edges of the third warning zone AR3 may be in the form of arcs with their respective radii corresponding to the respective moving speeds of the left and right crawlers 2R and 2L.

Further, the distance D for the third warning zone AR3 may be set according to the slewing angle of the slewing body 3 and/or the position of the working device 4 instead of the requested travel seed of the traveling body 2. For example, in the case where the travel direction of the traveling body 2 is the retreating direction, it may be configured to calculate the amount of rearward projection of the slewing body 3 from the rear end of the traveling body 2 based on the detection data indicating the slewing angle of the slewing body 3 and set the distance D to become greater as the calculated projection amount increases.

On the other hand, for example, in the case where the travel direction of the traveling body 2 is the advancing direction, it may be configured to calculate the amount of forward projection of the working device 4 from the front end of the traveling body 2 based on the detection data indicating the slewing angle of the slewing body 3 and the detection data indicating the position of the working device 4 and set the distance D to become greater as the calculated projection amount increases.

Further, the third warning zone AR3 may be set such that its width (the width in the left and right direction of the traveling body 2) varies according to the slewing angle of the slewing body 3 and/or the position of the working device 4. For example, it may be configured to calculate the overall width of the hydraulic excavator 1 in the left and right direction of the traveling body 2 based on the detection data indicating the slewing angle of the slewing body 3 and the detection data indicating the position of the working device 4 and set the third warning zone AR3 to have a width equal to the overall width or a width obtained by adding a predetermined margin value to the overall width.

Returning to FIG. 3, at step S4, the first warning zone AR and the second warning zone AR2 are set if a slewing motion of the slewing body 3 has been requested and the third warning zone AR3 is set if a travel motion of the traveling body 2 has been requested, as described above. If both a slewing motion of the slewing body 3 and a travel motion of the traveling body 2 have been requested, a composite area consisting of the first to third warning zones AR1, AR2, and AR3 is set as the waring area. At this time, the third warding area AR3 is usually combined with the first warning zone AR1 or the second warning zone AR2.

Next, at step S5, the controller 30 controls the projector light sources 28 to project light to the warning zone set at step S4. The operation at step S5 is performed by the light projection control section 32.

At this operation, the light projection control section 32 controls the projector light sources 28 to illuminate the set warning zone with visible light in a color or pattern that allows a person to visually distinguish the set warning zone from the other areas. Consequently, the visible light is projected to the warning zone to form a predetermined display.

At this time, part of the warning zone may additionally include, as the predetermined display, visible light information in the form of a text or graphic indicating that the warning zone is off-limits. In addition, in order to facilitate the visual recognition of the visible light projected to the warning zone, the projected visible light may be made to change its color or pattern between daytime and nighttime, for example.

The light projection to (illumination of) the warning zone performed in the above-described manner allows a person P in the vicinity of the hydraulic excavator 1 to easily visually distinguish the warning zone set in the vicinity of the hydraulic excavator 1 from the other areas, as shown in FIGS. 4A to 6B. This makes it possible to effectively prevent the person P in the vicinity of the hydraulic excavator 1 from entering the warning zone.

In addition, the set warning zone is a partial area of the entire area (entire circular area) around the hydraulic excavator 1 that is set according to the slewing speed of the slewing body 3, the travel speed of the traveling body 2, and the position of the working device 4, which makes it possible to prevent the warning zone from becoming excessively large. This in turn makes it possible to prevent excessive restriction of movement or actions of a worker in the vicinity of the hydraulic excavator 1. Further, it is also possible to appropriately set the position and the size of the warning zone according to the operational state of the hydraulic excavator 1.

It should be noted that in the first embodiment, the operations performed by the controller 30 (the operations in the flowchart of FIG. 3) do not use detection data obtained by the slewing velocity detector 21, the travel velocity detector 22, and the object detector 25. Therefore, the slewing velocity detector 21, the travel velocity detector 22, and the object detector 25 may be omitted in the first embodiment.

### Second Embodiment

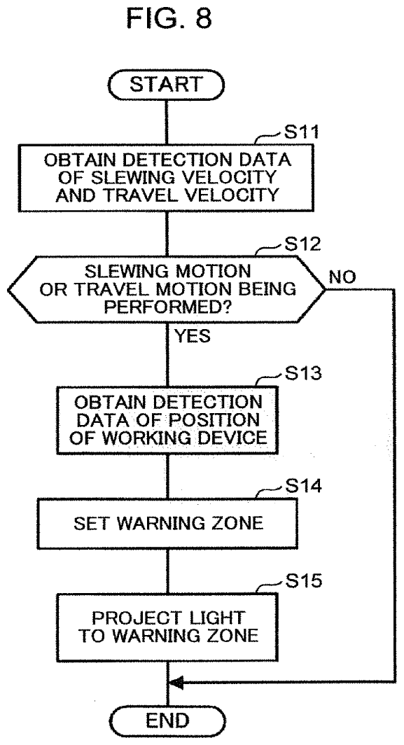

Next, a second embodiment of the present invention will be described with reference to FIG. 8. The second embodiment differs from the first embodiment mainly in some of the operations performed by the controller 30. Thus, the description given below mainly focuses on such difference from the first embodiment and omits features common with the first embodiment.

In the second embodiment, the controller 30 successively performs operations shown in the flowchart of FIG. 8 at a predetermined control processing cycle during operation of the hydraulic excavator 1. At step S11, the controller 30 obtains detection data indicating a current slewing velocity of the slowing body 3 and detection data indicating a current travel velocity of the traveling body 2 respectively from the slewing velocity detector 21 and the travel velocity detector 22.

Next, at step S12, the controller 30 determines, based on the detection data obtained at step S11, whether a slewing motion of the slewing body 3 or a travel motion of the traveling body 2 is being performed.

At this time, the controller 30 determines that the slewing body 3 is performing a slewing motion (YES at step S12) if the detected value of the slewing velocity of the slewing body 3 is outside a predetermined range around zero, and determines that the traveling body 2 is performing a travel motion (YES at step S12) if the detected value of the travel velocity of the traveling body 2 is outside a predetermined range around zero.

If a negative determination is made at step S12 (NO at step S12) (in the case where neither a slewing motion nor a travel motion is being performed), the controller 30 terminates the processing shown in FIG. 3 at the current control processing cycle.

If a positive determination is made at step S12 (YES at step S12) (in the case where one or both of a slewing motion and a travel motion are being performed), the controller 30, at the subsequent step S13, obtains detection data indicating a current position of the working device 4 from the working device position detector 23.

Next, at step S14, the controller 30 sets the warning zone in the vicinity of the hydraulic excavator 1. At this time, in the case where the slewing body 3 is performing a slewing motion, the controller 30 (the warning zone setting section 31) sets the first warning zone AR1 and the second warning zone AR2 in the same manner as in the first embodiment.

However, in the second embodiment, the angle θ1 for the first warning zone AR1 and the angle θ2 for the second warning zone AR2 are set according to the detected value of the slewing velocity of the slewing body 3 indicated by the detection data obtained at step S11, as shown in FIG. 7A. In other words, the angle θ1 and the angle θ2 are set according to the detected value of the slewing velocity to become greater as the slewing velocity of the slewing body 3 increases.

On the other hand, in the case where the traveling body 2 is performing a travel motion, the controller 30 (the warning zone setting section 31) sets the third warning zone AR3 in the same manner as in the first embodiment.

However, in the second embodiment, the distance D for the third warning zone AR3 is set according to the detected value of the travel velocity of the traveling body 2 indicated by the detection data obtained at step S11, as shown in FIG. 7B. In other words, the distance D is set according to the detected value of the travel velocity to become greater as the travel velocity of the traveling body 2 increases.

In the case where both a slewing motion of the slewing body 3 and a travel motion of the traveling body 2 are being performed, a composite area consisting of the first to third warning zones AR1 to AR3 is set as the warning zone, in the same manner as in the first embodiment.

The operation of setting the warning zone at step S14 is the same as that of the first embodiment except for the points described above.

Next, at step S15, the controller 30 controls the projector light sources 28 to project light to the warning zone set at step S4, using the light projection control section 32. The operation at step S15 is the same as the operation performed at step 5 in the first embodiment.

The second embodiment is the same as the first embodiment except for the points described above. By the way, in the second embodiment, the slewing velocity detector 21 and the travel velocity detector 22 correspond to the first operational information acquisition section of the present invention. In this case, the detected value of the slewing velocity including the slewing direction of the slewing body 3 corresponds to the first operational information and also to the detection information (directional information and speed information) relating to a direction and a speed of the slewing motion, and the detected value of the travel velocity including the travel direction of the traveling body 2 corresponds to the first operational information and also to the detection information (directional information and speed information) relating to a direction and a speed of the travel motion.

Further, similarly to the first embodiment, the working device position detector 23 corresponds to the second operational information acquisition section of the present invention, the warning zone setting section 31 corresponds to the zone setting section of the present invention, and the light projection control section 32 and the projector light sources 28 correspond to the display forming section of the present invention.

In the above-described second embodiment, the warning zone is set and light is projected to the warning zone during a slewing motion of the slewing body 3 or a travel motion of the traveling body 2 as described above. This makes it possible to provide the same advantageous effects as those of the first embodiment.

Further, in the second embodiment, the respective angles θ1 and θ2 for the first warning zone AR1 and the second warning zone AR2 are set according to the detection data indicating the actual slewing velocity of the slewing body 3, and the distance D for the third warning zone AR3 is set according to the detection data indicating the actual travel velocity of the traveling body 2.

This makes it possible, even if there is a delay in changing the actual slewing velocity of the slewing body 3 or the actual travel velocity of the traveling body 2 in response to a change in the control command for the slewing hydraulic motor 7 or the travel hydraulic motors, to set the first warning zone AR1 and the second warning zone AR2 to have sizes appropriate to the actual slewing velocity of the slewing body 3 in real time and set the third warning zone AR3 to have a size appropriate to the actual travel velocity of the traveling body 2 in real time.

It should be noted that in the second embodiment, the operations performed by the controller 30 (the operations in the flowchart of FIG. 8) do not use detection data obtained by the control command detector 24 and the object detector 25. Therefore, the control command detector 24 and the object detector 25 may be omitted in the second embodiment.

### Third Embodiment

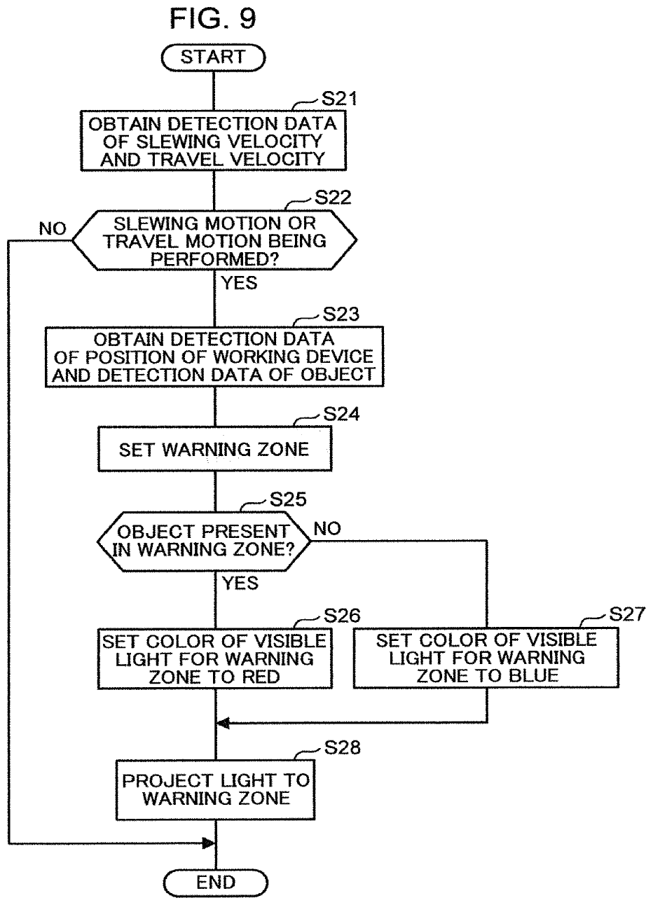

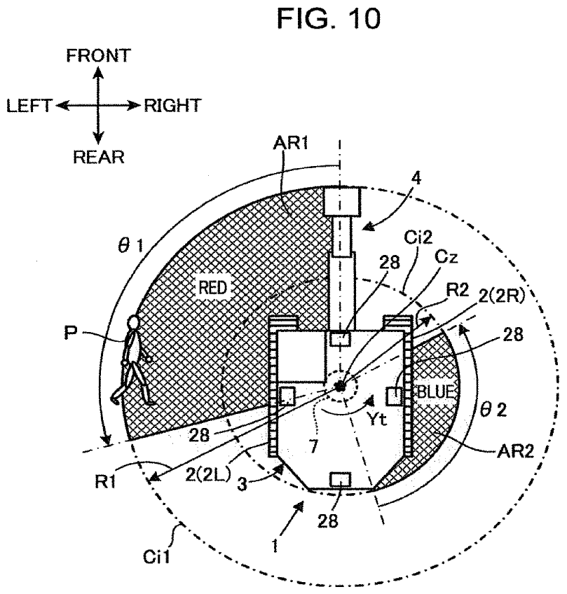

Next, a third embodiment of the present invention will be described with reference to FIGS. 9 and 10. The third embodiment differs from the first embodiment or the second embodiment mainly in some of the operations performed by the controller 30. Thus, the description given below mainly focuses on such difference from the first embodiment or the second embodiment and omits features common with the first embodiment or the second embodiment.

In the third embodiment, the controller 30 successively performs operations shown in the flowchart of FIG. 9 at a predetermined control processing cycle during operation of the hydraulic excavator 1. At step S21, the controller 30 obtains detection data indicating a current slewing velocity of the slewing body 3 and detection data indicating a current travel velocity of the traveling body 2 respectively from the slewing velocity detector 21 and the travel velocity detector 22.

Next, at step S22, the controller 30 determines, based on the detection data obtained at step S21, whether a slewing motion of the slewing body 3 or a travel motion of the traveling body 2 is being performed. This determination operation is the same as the determination operation at step S12 in the second embodiment.

If a negative determination is made at step S22 (NO at step S22) (in the case where neither a slewing motion nor a travel motion is being performed), the controller 30 terminates the processing shown in FIG. 9 at the current control processing cycle.

If a positive determination is made at step S22 (YES at step S22)(in the case where one or both of a slewing motion and a travel motion are being performed), the controller 30, at the subsequent step S23, obtains detection data indicating a current position of the working device 4 from the working device position detector 23 and detection data relating to an object in the vicinity of the hydraulic excavator 1 from the object detector 25.

Next, at step S24, the controller 30 sets the warning zone in the vicinity of the hydraulic excavator 1. This operation is the same as the operation at step S4 in the second embodiment.

Next, at step S25, the controller 30 determines, based on the detection data obtained from the object detector 25, whether there is an object or person in the set warning zone.

Subsequently, at steps S26 and S27, the controller 30 determines the type of visible light to be projected to the warning zone, such that the type of visible light projected when a positive determination has been made at step S25 is different from that when a negative determination has been made at step S25.

Specifically, if a positive determination is made at step 25 (YES at step S25), the controller 30 sets, at step S26, the color of visible light to be projected to a portion (a continuous area) of the set warning zone where an object has been detected, to a predetermined strong color (such as red) that can effectively call attention to the warning zone. In addition, the controller 30 sets the color of visible light to be projected to the other portion of the warning zone where no object has been detected (a portion of the warning zone that is apart from the portion where the object has been detected), to a predetermined color (such as blue) different from the above-mentioned strong color.

For example, as shown in FIG. 10, when it is detected in the first warning zone AR1 and the second warning zone AR2 set at step S24, during the slewing motion of the slewing body 3, that a person P is in the first warning zone AR1 and no object is in the second warning zone AR2, the color of visible light to be projected to the first warning zone AR1 is set to a strong color (such as red) and the color of visible light to be projected to the second warning zone AR2 is set to a color (such as blue) different from the strong color. In other words, the third embodiment allows the warning zone setting section 31 to set in the vicinity of the hydraulic excavator 1 a plurality of warning zones independent of each other. When the object detector 25 has detected an object in one (the first warning zone AR1) of the plurality of warning zones and has not detect any object in the other (the second warning zone AR2) of the plurality of warning zones, the light projection control section 32 and the projector light sources 28 form a first display (also referred to as “first visible image”, which is projected light of a strong color) in the one warning zone and display a second display (also referred to as “second visible image”, which is projected light of a color different from the strong color) different from the first display in the other warning zone.

In the case where the warning zone set at step S24 is a single continuous area, the color of visible light for the entire warning zone is set to the strong color at step S26. In other words, the light projection control section 32 and the projector light sources 28 form the first display (also referred to as “first visible image”, which is projected light of the strong color) in the warning zone when the object detector 25 has detected an object in the warning zone and form the second display (also referred to as “second visible image”, which is projected light of the color different from the strong color) different from the first display in the warning zone when the object detector 25 has not detect any object in the warning zone.

As described above, the first display and the second display are formed in different colors from each other. This allows a person having entered the warning zone to readily recognize that he/she has entered an off-limits area.

In addition, it may also be configured to change the tone of the color of visible light for the warning zone where an object has been detected, for example, between a portion of the zone in the vicinity of the position of the object and the other portion of the zone (for example, such that the depth of the strong color increases as closer to the position of the object).

On the other hand, if a negative determination is made at step S25 (NO at step S25), the controller 30 sets, at step S27, the color of visible light to be projected to the entire warning zone to a color (such as blue) different from the strong color.

Next, at step S28, the controller 30 controls the projector light sources 28 to project light to the warning zone set at step S24. At this time, the projector light sources 28 are controlled to project visible light to the warning zone in the color set in the above-described manner, whereby the predetermined display (also referred to as “visible image”, an image formed by the visible light) is formed.

The third embodiment is the same as the first embodiment and the second embodiment except for the points described above. By the way, in the third embodiment, the slewing velocity detector 21 and the travel velocity detector 22 correspond to the first operational information acquisition section of the present invention, similarly to the second embodiment. In addition, similarly to the first embodiment, the working device position detector 23 corresponds to the second operational information acquisition section of the present invention, the warning zone setting section 31 corresponds to the zone setting section of the present invention, the light projection control section 32 and the projector light sources 28 correspond to the display forming section of the present invention, and the object detector 25 corresponds to the object detection section of the present invention.

In the above-described third embodiment, the warning zone is set and light is projected to the warning zone during a slewing motion of the slewing body 3 or a travel motion of the traveling body 2 as described above. This makes it possible to provide the same advantageous effects as those of the first embodiment or the second embodiment.

In addition, by differentiating the color of visible light projected to a warning zone where an object has been detected from the color of visible light projected to a warning zone where no object has been detected, it is possible, when a person in the vicinity of the hydraulic excavator 1 has entered the warning zone to change the color (display or visible image) for the warning zone to the strong color. This allows the person having entered the warning zone to readily recognize that he/she has entered an off-limits area.

Further, in the third embodiment, the color of visible light projected to the warning zone where the object has been detected is differentiated from the color of visible light projected to the warning zone where no object has been detected, as described above. However, it may be configured to differentiate not only the color but also the intensity and/or the pattern, text or graph of visible light to be projected to the warning zone where the object has been detected from those of the warning zone where no object has been detected.

It should be noted that in the third embodiment, the operations performed by the controller 30 (the operations in the flowchart of FIG. 9) do not use detection data obtained by the control command detector 24. Therefore, the control command detector 24 may be omitted in the third embodiment.

However, the operations at steps S1 and S2 in the first embodiment may be performed instead of the above-described steps S21 and S22. In this case, the slewing velocity detector 21 and the travel velocity detector 22 may be omitted.

The above-described embodiments do not represent the full scope of the present invention, but rather the invention may be employed in other embodiments. For example, the construction machine according to the present invention is not limited to the form of a hydraulic excavator 1, but may be a construction machine of a type only capable of performing either a slewing motion or a travel motion.

In addition, the working device does not necessarily have a structure including a boom, an arm, and an attachment.

Further, the controller 30 may include part of the processing functions of the slewing velocity detector 21, the travel velocity detector 22, the working device position detector 23, the control command detector 24, or the object detector 25.

Further, the controller 30 may be disposed outside the hydraulic excavator 1 (the construction machine).

Further, in the case where the construction machine is of a type that works inside a building, for example, the projector light sources 28 may be installed on the ceiling.

Further, the display forming section according to the present invention does not necessarily project visible light directly to the warning zone but may be configured to cause fluorescent materials to emit visible light to the warning zone, for example. Alternatively, the display forming section may be configured to use other means to form a visible light display in the warning zone.

Further, the angles θ1 and θ2 set for the first warning zone AR1 and the second warning zone AR2 during a slewing motion of the slewing body 3 may be set reflecting not only the slewing velocity but also the slewing acceleration. For example, the angles θ1 and θ2 may be made greater when the slewing velocity accelerates than those at a constant velocity, or the angles θ1 and θ2 may be made smaller when the slewing velocity decelerates than those at the constant velocity.

Similarly, the distance D set for the third warning zone AR3 during a travel motion of the traveling body 2 may be set reflecting not only the travel velocity but also the travel acceleration. For example, the distance D may be made greater when the travel velocity accelerates than that at a constant velocity, or the distance D may be made smaller when the travel speed decelerates than that at the constant velocity.

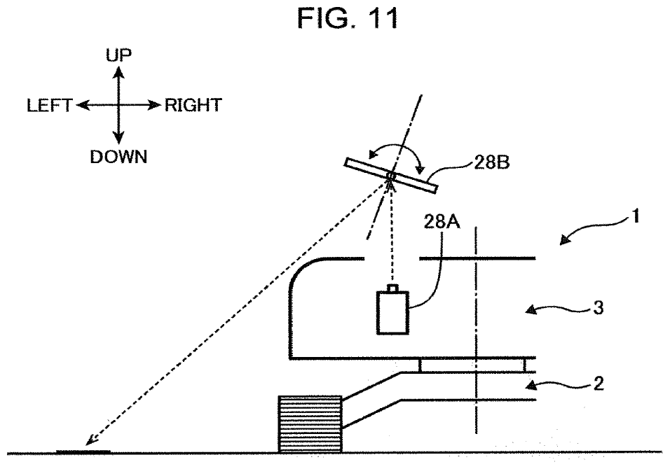

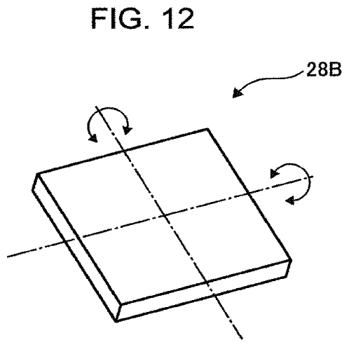

In the first embodiment described above, the plurality of projector light sources 28 are attached to the peripheral portion of the slewing body 3, and each projector light source 28 is configured to variably control the area to be illuminated with visible light within a predetermined range. FIG. 11 is a schematic sectional view for explaining functions of a projector light source 28A and a reflecting mirror 28B (each corresponding to the display forming section) according to a modified embodiment of the present invention. FIG. 12 is a perspective view showing rotational directions of the reflecting mirror 28.

As shown in FIG. 11, the projector light source 28A according to the modified embodiment is fixed to the slewing body 3 with its emission direction of visible light set upward. The projector light source 28A is, for example, a laser light source. The reflecting mirror 28B included in the alarm device for a construction machine is pivotally supported on an unillustrated bracket fixed to the slewing body 3. The visible light emitted from the projector light source 28A controlled by the light projection control section 32 (FIG. 2) is reflected by the reflecting mirror 28B to be incident on the ground. The project control section 32 sets (changes) the rotational direction (the light reflection direction) of the reflecting mirror 28B according to the position and size of the warning zone, for example. The reflecting mirror 28B is pivotally supported about two rotational axes orthogonal to each other as shown in FIG. 12. This makes it possible to change the area on the ground illuminated with visible light in two dimensions, thereby varying the warning zone. It is desirable that a plurality of projector light sources 28A and a plurality of reflecting mirrors 28B configured in the same manner as those described above are fixed to the slewing body 3 at different positions from each other.

As described above, the present invention provides an alarm device for a construction machine, comprising: a first operational information acquisition section for obtaining first operational information indicating a state of at least either a slewing motion or a travel motion of the construction machine; a zone setting section for setting in the vicinity of the construction machine a warning zone for providing a warning to a person in the vicinity of the construction machine according to the first operational information obtained by the first operational information acquisition section; and a display forming section for forming in the warning zone a display that allows the person in the vicinity of the construction machine to visually recognize the warning zone, using visible light.

In the above configuration, it is preferable that the first operational information includes directional information which is information relating to a direction of the at least either the slewing motion or the travel motion of the construction machine and that the zone setting section sets a position of the warning zone according to the directional information obtained by the first information acquisition section.

In the above configuration, it is preferable that the first operational information includes speed information which is information relating to a speed of the at least either the slewing motion or the travel motion of the construction machine and that the zone setting section sets a size of the warning zone according to the speed information obtained by the first operational information acquisition section.

In the above configuration, it is preferable that the alarm device further comprises a second operational information acquisition section for obtaining second operational information indicating a state of operation of a movable working device mounted on the construction machine and that the zone setting section sets the warning zone according to the first operational information obtained by the first operational information acquisition section and the second operational information obtained by the second operational information acquisition section

In the above configuration, it is preferable that the alarm device further comprises an object detection section capable of detecting an object in the vicinity of the construction machine and that the display forming section forms a first display in the warning zone when the object detection section has detected an object in the warning zone, and forms a second display different from the first display in the warning zone when the object detection section has detected no object in the warning zone.

In the above configuration, it is preferable that the alarm device further comprises an object detection section capable of detecting an object in the vicinity of the construction machine and that the zone setting section is capable of setting a plurality of warning zones independent of each other in the vicinity of the construction machine and when the object detection section has detected an object in one of the plurality of warning zones and no object in the other of the plurality of warning zones, the display forming section displays a first display in the one of the warning zones and forms a second display different from the first display in the other of the warning zones.

In the above configuration, it is preferable that the display forming section forms the first display and the second display in different colors from each other.

1. An alarm device for a construction machine, comprising:
a first operational information acquisition section for obtaining first operational information indicating a state of at least either a slewing motion or a travel motion of the construction machine;
a zone setting section for setting in the vicinity of the construction machine a warning zone for providing a warning to a person in the vicinity of the construction machine according to the first operational information obtained by the first operational information acquisition section; and
a display forming section for forming in the warning zone a display that allows the person in the vicinity of the construction machine to visually recognize the warning zone, using visible light.

2. The alarm device according to claim 1, wherein
the first operational information includes directional information which is information relating to a direction of the at least either the slewing motion or the travel motion of the construction machine, and
the zone setting section sets a position of the warning zone according to the directional information obtained by the first information acquisition section.

3. The alarm device according to claim 1, wherein
the first operational information includes speed information which is information relating to a speed of the at least either the slewing motion or the travel motion of the construction machine, and
the zone setting section sets a size of the warning zone according to the speed information obtained by the first operational information acquisition section.

4. The alarm device according to claim 1, further comprising:
a second operational information acquisition section for obtaining second operational information indicating a state of operation of a movable working device mounted on the construction machine, wherein
the zone setting section sets the warning zone according to the first operational information obtained by the first operational information acquisition section and the second operational information obtained by the second operational information acquisition section.

5. The alarm device according to claim 1, further comprising:
an object detection section capable of detecting an object in the vicinity of the construction machine, wherein
the display forming section forms a first display in the warning zone when the object detection section has detected an object in the warning zone, and forms a second display different from the first display in the warning zone when the object detection section has detected no object in the warning zone.

6. The alarm device according to claim 1, further comprising:
an object detection section capable of detecting an object in the vicinity of the construction machine, wherein
the zone setting section is capable of setting a plurality of warning zones independent of each other in the vicinity of the construction machine, and
when the object detection section has detected an object in one of the plurality of warning zones and no object in the other of the plurality of warning zones, the display forming section displays a first display in the one of the warning zones and forms a second display different from the first display in the other of the warning zones.

7. The alarm device according to claim 5, wherein
the display forming section forms the first display and the second display in different colors from each other.
